(19) United States
(12) Patent Application Publication
(10) Pub. No.: US 2025/0339850 A1
(43) Pub. Date: Nov. 6, 2025

(54) METHOD FOR MANUFACTURING EXHAUST GAS-PURIFYING CATALYST FOR INHIBITING SINTERING OF ACTIVE PRECIOUS METAL COMPONENT

(71) Applicant: HEESUNG CATALYSTS CORPORATION, Gyeonggi-do (KR)

(72) Inventors: Gwang Sub Go, Gyeonggi-do (KR); Kwi Yeon Lee, Seoul (KR); Jae Young Park, Gyeonggi-do (KR); Han Beyol Park, Gyeonggi-do (KR); Jin Woo Song, Incheon (KR)

(21) Appl. No.: 18/722,643

(22) PCT Filed: Nov. 16, 2022
(86) PCT No.: PCT/KR2022/018063

§ 371 Date: Nov. 18, 2024

(30) Foreign Application Priority Data
Dec. 22, 2021 (KR) 10-2021-0184518

(51) Int. Cl. B01J 37/02; B01D 53/94; B01J 21/04; B01J 23/44; B01J 35/40; B01J 35/64; B01J 37/04; B01J 37/08; B01J 37/16

(52) U.S. Cl. CPC B01J 37/0217; B01D 53/945; B01J 21/04; B01J 23/44; B01J 35/40; B01J 35/647; B01J 35/651; B01J 37/04; B01J 37/088; B01J 37/16; B01D 2255/1023; B01D 2257/404; B01D 2257/502; B01D 2257/702

(57) ABSTRACT

The present invention relates to a method for manufacturing an exhaust gas-purifying catalyst, wherein an active precious metal component is prevented from being sintered in a high-temperature aging condition. More specifically, the present invention relates to a manufacturing method in which a precious metal component within micropores of a support of a three-way catalyst for purifying exhaust gas is grown to the size of the micropores and thus is prevented from escaping to the outside of the micropore, and the chemical bond of the active precious metal component to the inner surface of the micropores is strengthened, whereby the precious metal component is repressed from being sintered in a high-temperature aging condition, and a catalyst, manufactured thereby, for purifying exhaust gas, wherein the active precious metal component is minimally sintered.

### TECHNICAL FIELD

The present disclosure relates to a preparation method of an exhaust gas-purifying catalyst in which an active precious metal component is prevented from being sintered under a high-temperature aging condition. More specifically, the present disclosure relates to a preparation method in which a precious metal component in the micropores of a support of a three-way catalyst for purifying exhaust gas is grown to the size of the micropores to prevent the precious metal component from escaping from the micropores to the outside and to strengthen the chemical bond of the active precious metal component to the inner surface of the micropores, whereby the precious metal is prevented from being sintered under a high-temperature aging condition, and to an exhaust gas-purifying catalyst prepared thereby, in which the active precious metal component is sintered at a minimum level.

### BACKGROUND ART

Catalysts for purifying exhaust gas, especially three-way catalysts, reduce hazardous components in automobile exhaust gases, for example, CO and HC through oxidation reactions and NOx through reduction reactions. A catalyst body is composed of a carrier made of ceramic and a wash-coat applied on the carrier.

The wash-coat contains precious metal components supported on a support, such as alumina and/or mixed oxides. As the precious metal components in three-way catalysts, a Pt/Pd/Rh three-way precious metal system, including Pt, Rh, and Pd, is used. It is known that Pt mainly promotes oxidation reactions that reduce CO and HC, Rh promotes NOx reactions, and Pd is advantageous for CO and HC light-off (reaction initiation temperature). In the case of three-way catalysts for purifying exhaust gas, exhaust gas regulations must be met under intense high-temperature conditions. However, precious metal components are sintered under high-temperature operating conditions of such catalysts. As a result, the purification performance of the three-way catalysts is observed to deteriorate.

### DISCLOSURE

### Technical Problem

The inventors of the present disclosure confirmed that under high-temperature aging conditions, the sintering of a precious metal active component in a three-way catalyst is promoted by aggregation of fine precious metal particles distributed on the surface of a support, aggregation of the fine precious metal particles, distributed in the micropores of the support, in the micropores, and aggregation on the surface of the support by escaping from the micropores, and that such fine precious metal particles grow into large particles when the sintering occurs on the surface of the support. Furthermore, the inventors confirmed that when the precious metal component is grown to the size of the pore diameter through reduction of the precious metal component in the micropores of the support, the precious metal particles were able to physically intact in the micropores, and the precious metal was preventable from being sintered even under high-temperature aging conditions of a three-way catalyst by chemical bonding to the inner portion of the micropores through reduction of the precious metal component, thereby completing the present disclosure.

### Technical Solution

The present disclosure provides a method of preparing an exhaust gas-purifying catalyst to prevent an active precious metal component from being sintered, the method enabling the precious metal component to be grown to a sufficiently large size in the micropores of a support by including the following steps: pre-milling a support in distilled water while mixing a precious metal compound, serving as a precious metal component; mixing the pre-milled support, mixed with the precious metal component, with a reducing agent to form a slurry; and coating a carrier with the slurry and sintering the resulting product. In the present disclosure, the reducing agent, instead of the precious metal component, may be first mixed with the pre-milled support. The inventors of the present disclosure confirmed that through the pre-milling, the precious metal component or the reducing agent is further well-dispersed in the micropores, so reduction reactions with other components, for example, the reducing agent or the precious metal component, in the micropores are thus secondarily promoted, thereby enabling precious metal particles in the micropores grown to a stable size at a level of the pore diameter to be obtained. In the present disclosure, the dispersibility of the precious metal component or the reducing agent may be improved through the pre-milling step, thereby facilitating the infiltration of these components into the micropores. Additionally, in the micropores of the support, the reduction reaction of the precious metal component is performed in a stirring step of the slurry in which the precious metal compound and the reducing agent are mixed, which may specifically be performed under a stirring condition for about 20 minutes. In the present disclosure, the precious metal component, reduced by the reducing agent to be grown to size at a level of the pore diameter, is preferably a platinum group component. Additionally, the support is selected from the group consisting of alumina, ceria, zirconia, and a mixture thereof, having a pore diameter in a range of 20 to 50 nm. As the reducing agent used, hydrazine, formaldehyde, formic acid, ascorbic acid, citric acid, glucose, glycerol, ethylene glycol, propylene glycol, diethylene glycol, ethanol, methanol, propanol, and butanol may be used and, preferably, ascorbic acid is used.

### Advantageous Effects

According to the present disclosure, the movement of precious metal particles is restricted through the reduction of a precious metal in the micropores of a support. As a result, the precious metal can be prevented from being sintered after high-temperature aging by at least 30% compared to the case otherwise. Additionally, by preventing the precious metal from being sintered, exhaust gas purification performance can be improved, and high-temperature durability can be enhanced. According to the present disclosure, the precious metal particles in the micropores of the support have a size grown 5 to 6 times larger than that of precious metal particles in existing three-way catalyst preparation methods. Additionally, in the support having a pore diameter at a level of about 20 nm, the precious metal particles in the micropores are grown to have a diameter at a level of about 15 to 20 nm.

### DESCRIPTION OF DRAWINGS

FIGS. 1A and 1B are conceptual diagrams for explaining a method of preventing a precious metal from being sintered in the present disclosure, wherein an existing catalyst preparation method in FIG. 1A enables precious metal particles having a size at a level of about 3 nm to be formed in the micropores of a support, whereas precious metal particles having a size at a level of about 20 nm are formed in the micropores of a support according to a method of the present disclosure in FIG. 1B, thereby minimizing the particles from escaping from the micropores to the outside and preventing the precious metal from being sintered on the surface of the support;

FIG. 2 is a diagram showing that when a precious metal aggregates due to the sintering of the precious metal resulting from catalyst aging, meaning that when the particles grow, the active sites of the precious metal component decrease, and exhaust gas purification performance deteriorates;

FIG. 3A is a flowchart for preparing an existing catalyst, and FIG. 3B is a flowchart for preparing a catalyst according to the present disclosure, wherein alumina having a pore diameter in a range of 15 to 20 nm as a support, 2 wt % of palladium-nitrate as a precious metal compound, ascorbic acid as a reducing agent, and a cordierite base as a carrier are used;

FIG. 4 shows a comparison of the mobility of precious metal particles grown in micropores, wherein the mobility of the precious metal particles prepared by a preparation method in the Example was greatly reduced compared to that of the precious metal particles prepared by the Comparative Example, which is understood be a result of the particles grown to a significantly large size in the micropores by the present disclosure and thus ultimately failing to escape from the micropores;

FIG. 5 is a diagram to compare the size of precious metal particles grown in micropores and the size of the precious metal particles after high-temperature aging (at 1,050° C.) according to the Example and the Comparative Example, wherein the size of the precious metal particles grown in the micropores according to the Comparative Example is 4 nm, whereas the size of the precious metal particles grown in the micropores according to the Example is 20 nm, leading to the expectation that the particles are challenging to escape from the micropores, and after the high-temperature aging, the precious metal particles in the Example are grown to a size of 100 nm, whereas the precious metal particles in the Comparative Example are grown to a size of 150 nm, leading to the expectation that the sintering of the precious metal is promoted by the Comparative Example, and thus the performance deteriorates; and

FIG. 6 is a diagram showing the dispersion degree of precious metal components in the presence or absence of pre-milling, wherein in the case of not involving the pre-milling, the dispersion degree of the precious metal was poor, but the dispersion degree of the precious metal component was improved with the pre-milling.

### BEST MODE

### Definition

In the present disclosure, pre-milling is a concept that contrasts with milling used in existing catalyst preparation methods. Unlike milling performed for the purpose of controlling the particle size of a support after adding all components, including a precious metal component and an auxiliary component, to the support, the pre-milling is understood to be performed by preliminarily milling a support while administering either one of the precious metal component or the auxiliary component to improve the dispersion degree of the administered component and, specifically, facilitate the infiltration into the micropores of the support. Additionally, the other component of the precious metal component or the auxiliary component is added after the pre-milling, so the pre-milling herein is different from the milling performed for the purpose of controlling the particle size of the support after adding all the components.

When a platinum group component is mixed in a three-way catalyst composition, platinum group particles aggregate due to high-temperature aging, and the surface decreases, resulting in catalyst deactivation. Therefore, there is a need to provide a catalyst containing a precious metal component that does not involve a decrease in the surface area so that the catalytic efficiency is allowed to remain high even under high-temperature conditions.

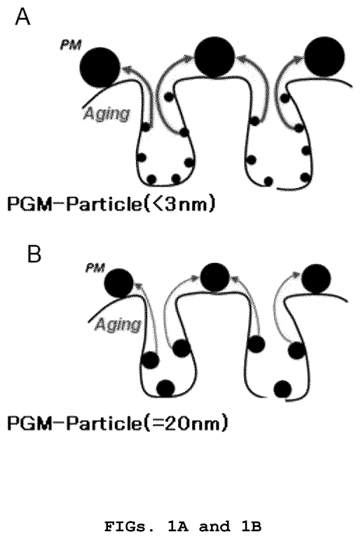

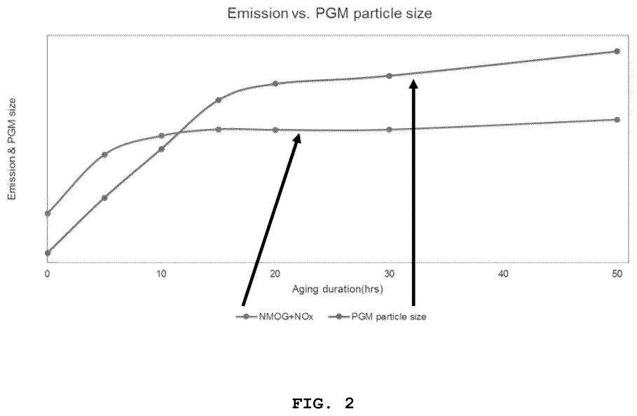

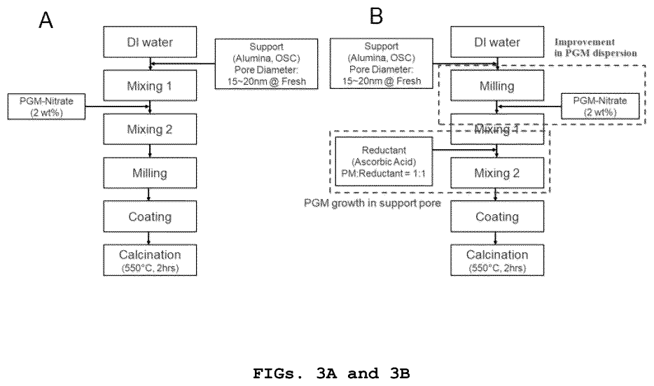

FIG. 3A schematically illustrates an existing three-way catalyst preparation method. First, a support containing alumina and other refractory metal oxides (OSC) is stirred in distilled water, mixed with a precious metal salt, and milled to complete the formation of a slurry, which is then used for the coating of a carrier and then sintered to prepare a catalyst body. In such a manner, precious metal particles having a size at a level of about 3 nm are formed in the micropores of the support, as illustrated in FIG. 1A. However, under high-temperature aging conditions of the catalyst, small particles formed in the micropores escape from the pores to the outside. As a result, aggregation proceeds, ultimately leading to the loss of the active sites of the precious metal component. FIG. 2 is a diagram showing that as the precious metal aggregates due to the sintering of the precious metal resulting from catalyst aging and thus the surface area decreases, the active sites of the precious metal component decrease, and exhaust gas purification performance deteriorates.

The present disclosure, which has been made to solve such a problem, proposes a method of growing precious metal particles having a size at a level equivalent to the pore diameter in the micropores of a support. FIG. 3B schematically illustrates a method of preparing a three-way catalyst of the present disclosure. According to the present disclosure, as shown in FIG. 1B, precious metal particles having a size at a level of about 20 nm are formed and kept in the micropores while being prevented from escaping, so the precious metal is prevented from being sintered on the surface of the support.

The method of preparing the precious metal particle-containing catalyst grown in the micropores of the support, according to the present disclosure, includes the following steps:
a. pre-milling a support in distilled water while mixing a precious metal compound, serving as a precious metal component, in the pre-milled support;
b. mixing the pre-milled support, mixed with the precious metal component, with a reducing agent to form a slurry; and
c. coating a carrier with the slurry and sintering the resulting product.

In a variant of the present disclosure, although a drying step may be involved before coating the carrier with the slurry and sintering the resulting product, the catalyst performance is not impaired by such a drying step. The drying is preferably performed at a temperature in a range of 130° C. to 150° C. for 10 to 20 minutes in an existing drying facility. Additionally, the sintering in step c is preferably performed at a temperature of 450° C. to 550° C. for 15 minutes to 3 hours.

In the present disclosure, a salt of Pd, Pt, Rh, or a mixture thereof is preferably used as the precious metal compound. The precious metal compound may be a salt, which is preferably a water-soluble salt. Such a precious metal compound is introduced into the support by being added to a solvent, which is preferably water, and stirring the resulting product, preferably at room temperature and at atmospheric pressure, wherein 1 to 2 wt % of the precious metal component, based on the weight of the final slurry, is preferably introduced into the support.

In the present disclosure, to grow the precious metal component, dispersed in the micropores of the support, to the size of the pore diameter, any water-soluble reducing agent, for example, hydrazine, formaldehyde, formic acid, ascorbic acid, citric acid, glucose, glycerol, ethylene glycol, propylene glycol, diethylene glycol, ethanol, methanol, propanol, and butanol may be used. Preferably, ascorbic acid is used. Additionally, the precious metal component and the reducing agent component may be used in a weight ratio of 1:1.

Suitable supports include alumina, ceria, or zirconia, as known to those skilled in the art. In particular, suitable supports have spherical forms, and the spherical support particles have an average pore diameter of 20 nm.

An alternative preparation method, according to the present disclosure, includes the following steps:
a. pre-milling a support in distilled water while mixing a reducing agent in the pre-milled support;
b. mixing the pre-milled support, mixed with the reducing agent, with a precious metal compound to form a slurry; and
c. coating a carrier with the slurry and sintering the resulting product.

Thus, the present disclosure is advantageous in that the precious metal component or the reducing agent is pre-milled with the support to improve the dispersion degree, thereby much simply and easily controlling the particle growth of the catalytically active component, and the precious metal may be prevented from being sintered under high-temperature conditions. Additionally, by preventing the precious metal from being sintered, exhaust gas purification performance is expected to be improved, and high-temperature durability is expected to be enhanced.

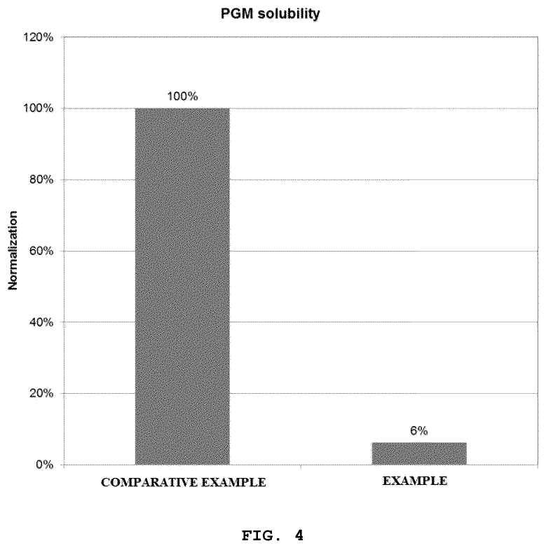

FIG. 4 shows a comparison of the mobility of the precious metal particles grown in the micropores, wherein the mobility of the precious metal particles prepared by the preparation method in the Example was greatly reduced compared to that of the precious metal particles prepared by the Comparative Example. Specifically, based on 100% of the mobility of the precious metal particles according to the Comparative Example, the mobility of the precious metal particles grown to the size of the micropores is measured to be 6%.

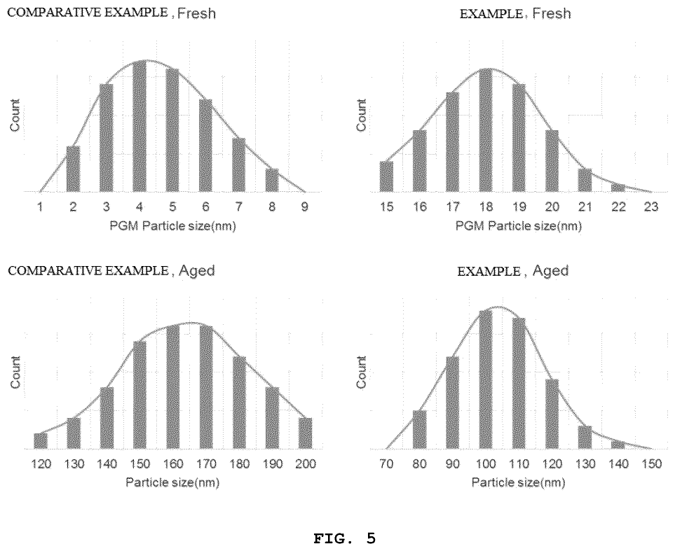

FIG. 5 is a diagram to compare the size of the precious metal particles grown in the micropores and the size of the precious metal particles after high-temperature aging (at 1,050° C.) by the Example and the Comparative Example, wherein the size of the precious metal particles grown in the micropores according to the Comparative Example is 4 nm, whereas the size of the precious metal particles grown in the micropores according to the Example is 20 nm, leading to the expectation that the particles are challenging to escape from the micropores, and after the high-temperature aging, the precious metal particles in the Example are grown to a size of 100 nm, whereas the precious metal particles in the Comparative Example are grown to a size of 150 nm, leading to the expectation that the sintering of the precious metal is promoted by the Comparative Example, and thus the performance deteriorates.

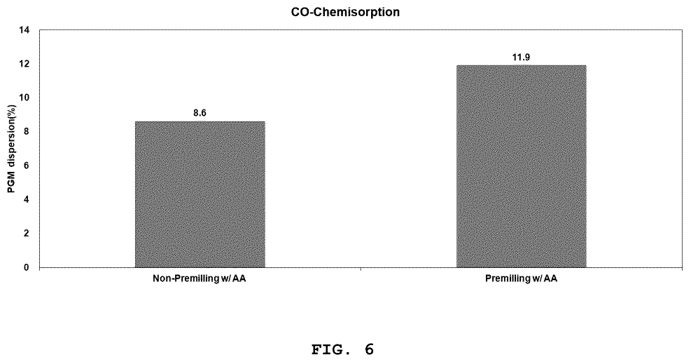

In the present disclosure, the dispersion degree of the precious metal component, according to the presence or absence of the pre-milling, is shown in FIG. 6. Compared to the case of not involving the pre-milling, when the pre-milling was performed after mixing the precious metal component in the support, the distribution of the precious metal on the surface of the support was improved by about 40%. Through the pre-milling, the slurry has a particle size at a level of about 50 μm or less, which is more specifically in a range of about 5 to 20 μm. The particle size was controlled by adjusting the mill rpm and pump rpm of a high-energy mill (manufacturer: Netzsch), which is more specifically performed under conditions at about 1500 to 2000 mill rpm and about 50 to 100 pump rpm.

Hereinafter, the present disclosure will be explained with reference to the following non-limiting examples.

### Comparative Example

An alumina support having a pore diameter in a range of 15 to 20 nm was stirred in distilled water while introducing 2 wt % of palladium-nitrate based on the weight of a slurry. The slurry was continuously stirred for 10 minutes and milled under conditions at 1500 to 2000 mill rpm and 50 to 100 pump rpm to adjust the particle size to a level of about 10 um. Then, a carrier was coated with the slurry, and the resulting product was sintered at a temperature of 550° C. for 2 hours to complete the preparation of a catalyst body.

### Example

An alumina support having a pore diameter in a range of 15 to 20 nm was stirred in distilled water and then pre-milled under conditions at 1500 to 2000 mill rpm and 50 to 100 pump rpm while introducing 2 wt % of palladium-nitrate based on the weight of a slurry. Subsequently, ascorbic acid was added in an amount the same as the wt % of the nitrate, and the resulting slurry was continuously stirred for 20 minutes. Then, a carrier was coated with the slurry, and the resulting product was sintered at a temperature of 550° C. for 2 hours to complete the preparation of a catalyst body.

The performance of the catalysts, prepared according to the Example and the Comparative Example, may be evaluated by a light-off temperature (LOT), which is defined as the temperature at which the conversion efficiency of the catalyst exceeds 50%. According to Table 1, in which the LOT measurement results of the fresh catalysts are summarized, the performance of the catalyst prepared by the Comparative Example is superior to that of the catalyst prepared by the Example. However, according to Table 2, in which the LOT measurement results of the aged catalysts are shown, the performance of the catalyst prepared by the Example appears to be superior to that of the catalyst prepared by the Comparative Example. These results show that the performance of the catalyst, according to the Example, is improved by effectively preventing the sintering under high-temperature aging conditions.

Table 1 Fresh catalyst performance evaluation LOT

TABLE 1

| | LOT HC | LOT CO | LOT NOx |
|---|---|---|---|
| Comparative Example | 250.3 | 239.5 | 242.1 |
| Example | 256.5 | 251.1 | 251.1 |

Table 2 Aged catalyst performance evaluation LOT

TABLE 2

| | LOT HC | LOT CO | LOT NOx |
|---|---|---|---|
| Comparative Example | 362 | 363 | 365 |
| Example | 356 | 357 | 357 |

On the other hand, in vehicle performance evaluation, the catalyst, according to the Example, is superior in the performance of CO removal by about 11% and NOx removal by about 21% compared to the catalyst according to the Comparative Example, which is determined to be attributable to the precious metal component that is prevented from being sintered by the particle growth thereof in the micropores of the support.

1. A method of preparing an exhaust gas-purifying catalyst to prevent an active precious metal component from being sintered, the method comprising:
pre-milling a support in distilled water while mixing a precious metal compound, serving as a precious metal component, with the pre-milled support;
mixing the pre-milled support, mixed with the precious metal component, with a reducing agent to form a slurry; and
coating a carrier with the slurry and sintering the resulting product.

2. A method of preventing an active precious metal from being sintered in an exhaust gas-purifying catalyst, the method comprising:
pre-milling a support in distilled water while mixing a reducing agent with the pre-milled support;
mixing the pre-milled support, mixed with the reducing agent, with a precious metal compound to form a slurry; and
coating a carrier with the slurry and sintering the resulting product.

3. The method of claim 1 or 2, wherein the pre-milling is performed under conditions at about 1500 to 2000 mill rpm and 50 to 100 pump rpm, so a particle size is in a range of about 5 to 20 um.

4. The method of claim 1 or 2, wherein the sintering is performed at a temperature in a range of 350° C. to 550° C. for 15 minutes to 3 hours.

5. The method of claim 1 or 2, wherein the precious metal compound is a platinum group compound.

6. The method of claim 1 or 2, wherein the support is selected from the group consisting of alumina, ceria, zirconia, and a mixture thereof, and
the support has a pore diameter in a range of 20 to 50 nm.

7. The method of claim 1 or 2, wherein the reducing agent is selected from the group consisting of hydrazine, formaldehyde, formic acid, ascorbic acid, citric acid, glucose, glycerol, ethylene glycol, propylene glycol, diethylene glycol, ethanol, methanol, propanol, and butanol, and
the reducing agent is preferably ascorbic acid.
